(19) United States
(12) Patent Application Publication
(10) Pub. No.: US 2025/0138705 A1
(43) Pub. Date: May 1, 2025

(54) METHOD, APPARATUS, MEDIUM AND ELECTRONIC DEVICE FOR INFORMATION PROCESSING

(71) Applicant: Beijing Zitiao Network Technology Co., Ltd., Beijing (CN)

(72) Inventor: Wenzong Ma, Beijing (CN)

(21) Appl. No.: 18/693,485

(22) PCT Filed: Sep. 21, 2022
(86) PCT No.: PCT/CN2022/120089

§ 371 Date: Mar. 19, 2024

(30) Foreign Application Priority Data
Sep. 22, 2021 (CN) 202111109223.8

(51) Int. Cl. G06F 3/0483; G06F 3/0484; G06F 21/62; G06F 40/166

(52) U.S. Cl. CPC G06F 3/0483; G06F 3/0484; G06F 21/6218; G06F 40/166

(57) ABSTRACT

The embodiments of the present discourse relate to a method, apparatus, medium and electronic device for information processing, and the method comprises: displaying a first interface in response to an input request received in a document page; displaying at least one piece of task information of a target user and reminder information of the task information in the first interface in response to a selection operation of a target user. The embodiments of the present discourse may improve information security.

### CROSS-REFERENCE TO RELATED APPLICATIONS

The present application claims priority to Chinese Patent Application No. 202111109223.8, filed on Sep. 22, 2021, entitled “METHOD, APPARATUS, MEDIUM AND ELECTRONIC DEVICE FOR INFORMATION PROCESSING”, which is hereby incorporated by reference in its entirety.

### FIELD

Embodiments of the present disclosure relate to the field of computer technologies, and in particular to a method for information processing, an apparatus information processing, and a computer-readable storage medium and an electronic device for implementing the method for information processing.

### BACKGROUND

At present, objective management tools such as objectives and key results (OKR for short) management applications have been widely used in business management. For example, the OKR management applications can fulfill functions such as establishment and recording of tasks such as to-do items, communication, document processing, etc., and can track the completion progress of to-do items and the like to assist users in time management, thereby establishing an effective workflow and improving the efficiency of multi-person collaborative work.

During the use of related OKR management applications, the OKR content of a user is often open to some relevant persons for viewing, resulting in the arbitrary use of the OKR content and poor information security.

### SUMMARY

In order to solve the above technical problems or at least partially solve the above technical problems, the present disclosure provides an information processing method, an information processing apparatus, and a computer-readable storage medium and an electronic device implementing the information processing method.

In a first aspect, the present embodiment provides a method for information processing, comprising:

Displaying a first interface in response to an input request received in a document page;

Displaying at least one piece of task information of a target user and reminder information of the task information in the first interface in response to a selection operation of a target user.

In a second aspect, the present embodiment provides aa apparatus for information processing, comprising:
An interface displaying module, for displaying a first interface in response to an input request received in a document page;
An information displaying module, for displaying at least one piece of task information of a target user and reminder information of the task information in the first interface in response to a selection operation of a target user.

In a third aspect, the present disclosure provides a non-transitory computer-readable storage medium storing a computer program thereon, the computer program, when executed by a processor, implementing steps of the method for information processing according to any one of the above-described embodiments.

In a fourth aspect, the present embodiment provides an electronic device, comprising:
A processor; and
A memory for storing computer programs;
Wherein the processor is configured to execute steps of the method for information processing according to any one of the above-described embodiments.

The technical solutions provided by the embodiments of the present disclosure have the following advantages compared with the prior art:

Embodiments of the present disclosure provides a method, apparatus, medium, and electronic device for information processing, displaying a first interface in response to an input request received in a document page; and displaying at least one piece of task information of a target user and reminder information of the task information in the first interface in response to a selection operation of a target user. In this way, after displaying the interface of a target application such as an OKR management application in the document page, when viewing one or more task information of the target user in the target application, reminder information will be displayed when displaying the task information, such as reminding the user that a task information is confidential and there is a risk of leakage, such that the user may handle it accordingly when editing the document to avoid content leakage, and improve the information security of target applications such as OKR management applications to a certain extent accordingly.

### BRIEF DESCRIPTION OF THE SEVERAL VIEWS OF THE DRAWINGS

The accompanying drawings herein, which are incorporated in and constitute a part of this specification, illustrate embodiments conforming to the present disclosure, and together with the specification, serve to explain the principles of the present disclosure.

For clearer description of the technical solutions in the embodiments of the present disclosure or in the prior art, the accompanying drawings needed to be used in the description of the embodiments or the prior art will be briefly introduced below. Obviously, for those of ordinary skill in the art, it is said that other drawings can be obtained from these accompanying drawings without exerting creative labor.

FIG. 1 illustrates a flowchart of an information processing method according to an embodiment of the present disclosure;

FIG. 2 illustrates a schematic diagram of a document page according to an embodiment of the present disclosure;

FIG. 3 illustrates a schematic diagram of a document page according to an embodiment of the present disclosure;

FIG. 4 illustrates a schematic diagram of a document page according to another embodiment of the present disclosure;

FIG. 5 illustrates a schematic diagram of a document page according to a further another embodiment of the present disclosure;

FIG. 6 illustrates a schematic diagram of a document page according to still another embodiment of the present disclosure;

FIG. 7 illustrates a schematic diagram of an information processing apparatus according to an embodiment of the present disclosure; and

FIG. 8 illustrates a schematic diagram of an electronic device for implementing an information processing method according to an embodiment of the present disclosure.

### DETAILED DESCRIPTION

To understand the above objects, features and advantages of the present disclosure more clearly, the following solutions of the present disclosure will be further described. It should be noted that, without conflict, the embodiments of the present disclosure and features in the embodiments may be combined with each other.

Many specific details are set forth in the following description in order to fully understand the present disclosure, but the present disclosure may also be employed in other ways different from that described herein to implement; Obviously, the descriptions of the embodiments are only part of the present disclosure, not all embodiments.

It should be understood that in the following text, term “at least one (item)” refers to one or more, and term “multiple” refers to two or more. Term “and/or” is used to describe the relationship between related objects, indicating that there may be three types of relationships, for example, term “A and/or B” may represent three situations: only A exists, only B exists, and both A and B exist at the same time, where A and B may be singular or plural. The character “/” generally indicates that the related objects before and after are a “or” relationship. Term “at least one (item) of the following” or similar expressions refer to any combination of these items, including any combination of single or plural items. For example, at least one (item) in a, b, or c may represent: a, b, c, “a and b”, “a and c”, “b and c”, or “a and b and c”, where a, b, and c may be single or multiple.

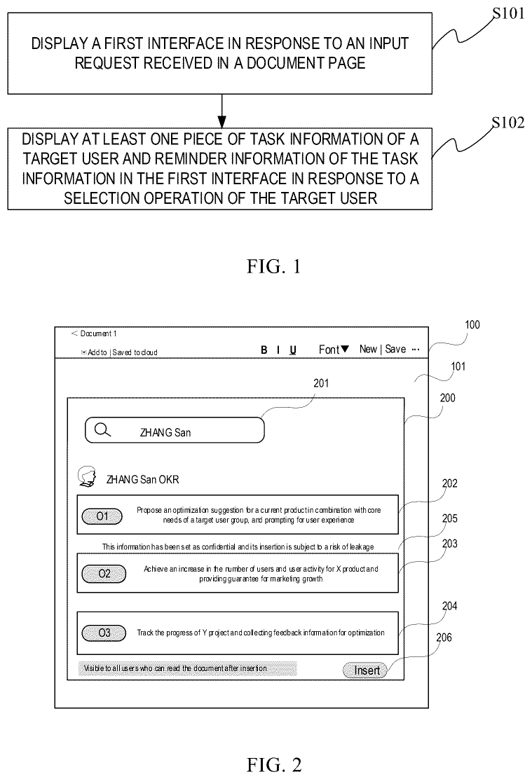

FIG. 1 illustrates a flowchart of a method for information processing according to embodiments of the present disclosure. The method is executable in an electronic device, such as a smart phone and a tablet computer. Specifically, the method may include the following steps.

In step S101, in response to an input request received in a document page, display a first interface.

Illustratively, the document page in this embodiment may be a page of an online document. The online document may be but not limited to, an online document that may be collaboratively edited by multiple people. In other examples, the document page may also be a page of a document processing application, without any limitations.

In an example, a document page 100, as shown in FIG. 2, may include an editing region 101 where a user may usually enter text and other information. When the user enters an input request in the editing region 101 of the document page 100, for example, a request to launch a target application, the display of the first interface 200 in the document page can be triggered. Illustratively, the first interface 200 may be an interface of the target application, such as an OKR application. In the first interface 200 such as the interface of the OKR application, the OKR information of the user may be viewed and manipulated, for example, selecting certain OKR information to insert into the document page 100.

In step S102, in response to a selection operation of the target user, display at least one piece of task information of the target user and reminder information of the task information in the first interface.

In some embodiments of the present application, the task information comes from a task system, and the task system and the online document belong to different application systems. The application systems of the task system and the online document may be integrated in the same software system; or the application systems of the two may be associated through the same user account.

Illustratively, in the first interface 200 such as the interface of the OKR application, a selection operation may be performed on the user, for example, selecting a target user. Selection a target user may trigger the display of the at least one piece of task information (for example, the OKR information) of the target user in the first interface such as the interface of the OKR application. Meanwhile, in this embodiment, when the task information (for example, the OKR information) of the target user is displayed in the first interface, such as the interface of the OKR application, reminder information may be displayed at the same time. The reminder information may be text reminder information, but it is not limited this.

According to the above information processing method shown in the embodiment of the present disclosure, when the interface of the target application (for example, the OKR management application) is displayed in the document page and one or more pieces of task information of the target user is viewed in the target application, the reminder information is displayed when the task information is displayed, for example, reminding the user that one piece of task information is confidential and is subject to the risk of leakage, so that the user may handle it accordingly when editing the document to avoid leakage of content, thereby improving the information security of the target application (for example, the OKR management application) to a certain extent.

Optionally, in an embodiment of the present disclosure, displaying the reminder information of the task information in step S102 includes: displaying first reminder information in a first region of the first interface.

As shown in FIG. 2, the first region may be but is not limited to a bottom region in the first interface 200 (for example, the interface of the OKR application), and the first reminder information may be text reminder information, which may be but not limited to, for example, “Visible to all users who can read the document after insertion”.

Optionally, in another embodiment of the present disclosure, displaying the reminder information of the task information in step S102 includes: displaying second reminder information in a second region associated with the display region of the task information in the first interface 200, wherein the second reminder information is determined based on a confidentiality type of the task information.

Illustratively, as shown in FIG. 2, for example, the target user “ZHANG San” has three pieces of task information in total, such as O1 information, O2 information and O3 information of OKR task information. The 01 information, the O2 information and the O3 information are respectively displayed in the first display region 202, a second display region 203 and a third display region 204 in the first interface 200. If a confidentiality type is set when a piece of task information such as the O2 information is created, the second reminder information may be displayed when the task information such as the O2 information, is displayed in the first interface 200 (for example, the interface of the OKR application). The second reminder information may also be text information, for example, “This information has been set as confidential and there is a risk of leakage when inserted”. The second region 205 may be an upper region immediately adjacent to the display region of the task information such as O2 information, that is, the second display region 203, but it is not limited thereto. The second reminder information such as “This information has been set as confidential and there is a risk of leakage when inserted”, may be displayed in the second region 205.

In some embodiments of the present application, the task information of the user is created in the task system of the user, and the user account of the task system and the user account of the document may be the same user's account, or the two accounts are accounts of different users in the same organization and have an association relationship. After the task information is created, the user may set a confidentiality type for the task information. For example, the confidentiality type may include: visible to oneself, visible to all, or visible to some people.

Optionally, in an embodiment of the present disclosure, before displaying the second reminder information in the second region associated with the task information in the first interface 200, the method further includes:
setting the confidentiality type of the task information to a first type in a client associated with the task information, wherein the first type indicates that the task information is confidential information.

Illustratively, the client may be an OKR application client. In the OKR application client, OKR information such as the 02 information may be created, and meanwhile, the first type of the O2 information may be set as confidential information. The first type may be represented by a character identification such as “1”, and a non-confidential type may be represented by a character identification such as “0”, but they are not limited thereto.

Optionally, in an embodiment of the present disclosure, the selection operation of the target user in step S102 includes: entering information of the target user in the editing region of the document page associated with the first interface 200; or entering information of the target user in a specified region of the first interface.

Illustratively, in an example, the information (for example, the name “ZHANG San”) of the target user may be entered in the editing region 101 of the document page 100, so that the target user “ZHANG San” may be selected. In another example, the information (for example, the name “ZHANG San”) of the target user may be entered in the specified region such as the upper region, in the first interface 200 such as the interface of the OKR application, so that the target user “ZHANG San” may be selected. In this way, the method for selection operation of the target user can be enriched, showing good operation flexibility.

Optionally, in an embodiment of the present disclosure, as shown in FIG. 2, the first interface 200 may further include a search component such as a search box 201. Accordingly, displaying at least one piece of task information of the target user in the first interface 200 includes: in response to the input content received in the search component, displaying the target user corresponding to the input content and at least one piece of task information of the target user in the first interface.

Illustratively, input content is entered in the search component such as the search box 201 in the first interface 200, the input content being for example the name “ZHANG San” of the target user; and then, the display of the target user and the task information (such as O1, O2, O3, etc.) of the target user in the first interface 200 may be triggered.

Optionally, in an embodiment of the present disclosure, the method may further include: displaying the task information in the document page in response to a trigger operation on an insert control or the task information in the first interface.

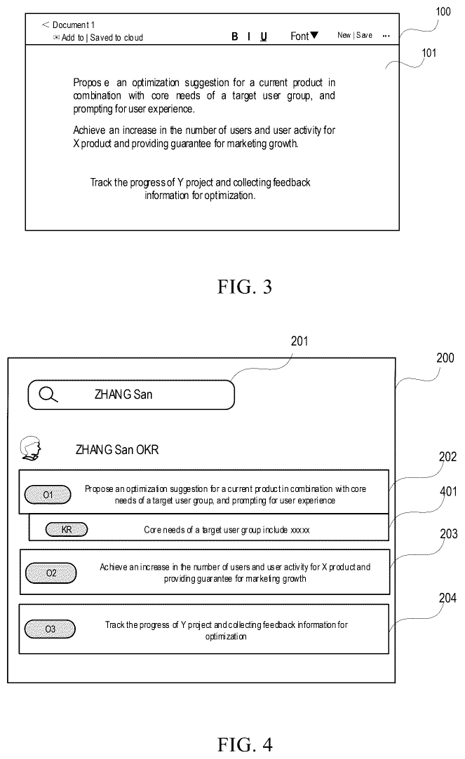

Illustratively, the first interface 200 may include an insert control such as an insert button 206. When the user clicks the insert button 206, the task information such as O1, O2 and O3 is displayed in the document page, that is, the task information in the OKR application is inserted into the edited document, as shown in FIG. 3. Alternatively, the user may directly perform a trigger operation, such as a mouse click operation or a touch click operation, on the task information such as O2 in the first interface 200, so as to display the task information such as O2 in the document page, that is, the task information O2 in the OKR application is inserted into the edited document.

Optionally, in an embodiment of the present disclosure, the method may further include: simultaneously displaying subordinate task information of the task information, wherein content of the subordinate task information is associated with content of the task information.

Illustratively, as shown in FIG. 4, when the task information such as the O1 information is displayed in for example the first interface 200, subordinate task information 401 (for example, KR information “Core needs of a target user group include xxxxx”) of the O1 information is displayed at the same time. In this way, all information contained in the OKR information of the target user may be displayed to facilitate the user in selecting to insert target information (for example, inserting certain O information and/or associated subordinate KR information) when editing a document in the document page 100.

Optionally, in an embodiment of the present disclosure, the method may further include: displaying a content input component in a region associated with the task information, or displaying a content input component in a region associated with the subordinate task information.

Illustratively, the content input component may be an input box, and the associated region may be, for example, a right region of the first display region 202 where the O1 information is located, but it is not limited thereto. The input box is displayed in the right region, for example. Alternatively, the input box is displayed in a region immediately adjacent to the right or below the display region of the subordinate KR information, i.e., in the region associated with the subordinate task information. In this way, the user is facilitated in entering of the task completion progress of the task information such as the 01 information and/or the KR information in the input box.

Optionally, in an embodiment of the present disclosure, the method may further include: determining whether a current user is the same as the target user, and if not, sending a prompt message to the target user, wherein the prompt message comprises identification information of the document.

Illustratively, the current user is an operating user currently editing the document in the document page 100. The identification information of the document may include, but is not limited to, document title, document name such as “Document 1”, document link such as uniform resource locator (URL), etc. When it is determined that the current user A and the target user such as “ZHANG San” are not the same user, a prompt message such as “User A is operating your OKR information” is sent to the target user such as “ZHANG San”. In this way, the target user may establish contact with the user A, for example, by means of an instant messaging application, and be reminded to pay attention to the risk of information leakage, thereby avoiding the content leakage of the task information such as the O2 information and improving information security.

Optionally, in an embodiment of the present disclosure, sending the prompt message to the target user includes: sending the prompt message to an instant messaging client of the target user by means of an associated message robot.

A message robot is, for example a chatbot, which may be provided in the document page 100. By means of the message robot such as the chatbot, the prompt message (for example, “User A is operating your OKR information”) may be sent to the instant messaging client (for example, an instant messaging application) of the target user such as “ZHANG San”. In this way, convenient message sending can be achieved.

In some embodiments, since the document link is automatically empowered in the OKR application, which may lead to information leakage, the prompt message sent may only include the name or title of the document, but not the document link. This can thus further avoid the content leakage of the task information such as the O2 information and improve information security.

Optionally, in an embodiment of the present disclosure, displaying the first interface in response to the input request for receiving the task information in the document page in step S101 includes: displaying a second interface in response to receiving information of the target user in the document page; and displaying the first interface in response to selecting a task control in the second interface.

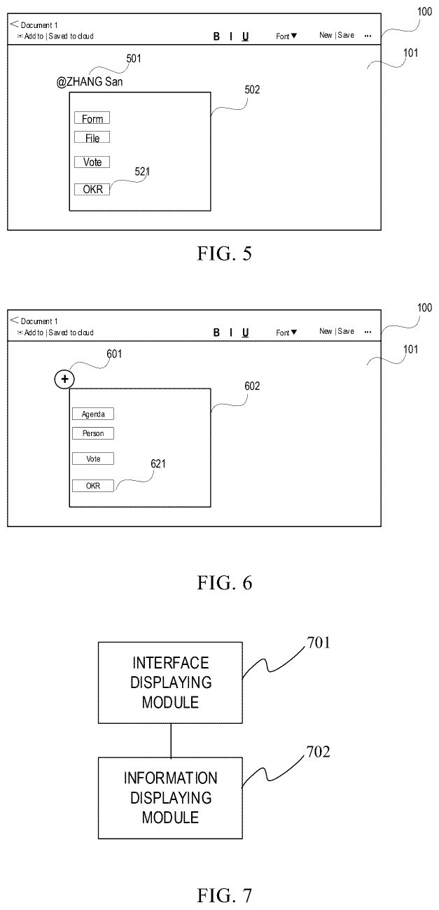

Illustratively, as shown in FIG. 5, when the user enters the target user information 501 (for example, a specified character plus user's name, such as “@ZHANG San”) in the editing region 101 of the document page 100, the display of the second interface 502 is triggered. The second interface 502 is for example a window interface. The window interface may include a plurality of task controls such as task buttons. Selecting a task button 521 corresponding to, for example, the OKR application may trigger the display of the first interface 200 (for example, the interface of the OKR application) as shown in FIG. 2.

Optionally, in another embodiment of the present disclosure, displaying the first interface in response to the input request for receiving the task information in the document page in step S101 includes: displaying a trigger component in response to a selection operation of a content line in the document page; displaying a third interface in response to a trigger operation of the trigger component; and displaying the first interface in response to selecting a task control in the third interface.

Illustratively, as shown in FIG. 6, for example, a selection operation is performed on any content line (which may be a blank content line) in the editing region 101 of the document page 100 to trigger the display of the trigger component, which may be a preset graphic button 601; and then, the trigger component (for example, the graphic button 601) is clicked to trigger the display of the third interface 602, which is, for example, a window interface. The window interface may include a plurality of task controls such as task buttons. Selecting a task button 621 corresponding to, for example, the OKR application, may trigger the display of the first interface 200 (for example, the interface of the OKR application) as shown in FIG. 2.

In the above embodiments of the present disclosure, the display of the first interface 200 (for example, the interface of the OKR application) may be triggered in different ways, and the operation method is flexible and convenient.

It should be noted that although the various steps of the method in this disclosure are described in a specific order in the attached figures, it does not require or imply that these steps must be executed according to that specific order, or that all the steps shown must be executed to achieve the desired result. Additionally or alternatively, some steps may be omitted, multiple steps may be merged into one step for execution, and/or one step may be decomposed into multiple steps for execution. In addition, it is easy to understand that these steps may be executed synchronously or asynchronously in multiple modules/processes/threads.

The present embodiment provides an apparatus for information processing. The apparatus for information processing shown in FIG. 7 may include:
An interface displaying module 701, for displaying a first interface in response to an input request received in a document page;
An information displaying module, for displaying at least one piece of task information of a target user and reminder information of the task information in the first interface in response to a selection operation of a target user.

Embodiments of the present disclosure provides an apparatus for information processing. After displaying the interface of a target application such as an OKR management application in the document page, when viewing one or more task information of the target user in the target application, reminder information will be displayed when displaying the task information, such as reminding the user that a task information is confidential and there is a risk of leakage, such that the user may handle it accordingly when editing the document to avoid content leakage, and improve the information security of target applications such as OKR management applications to a certain extent accordingly.

Optionally, in one embodiment of the present disclosure, the information display module 702 is used for displaying second reminder information in a second region associated with a display region of the task information in the first interface, the second reminder information being determined based on a confidentiality type of the task information.

Optionally, in one embodiment of the present disclosure, the apparatus further includes module used for before displaying the second reminder information in the second region associated with the task information in the first interface, setting a confidentiality type of the task information to a first type in a client associated with the task information, the first type indicating that the task information is confidential information.

Optionally, in one embodiment of the present disclosure, the selection operation of the information display module 702 on the target user comprises: entering information of the target user in an editing region of the document page associated with the first interface; or entering information of the target user in a specified region of the first interface.

Optionally, in one embodiment of the present disclosure, the first interface further comprises a search component; the information display module 702 is used for in response to input content received in the search component, displaying the target user corresponding to the input content and at least one piece of task information of the target user in the first interface.

Optionally, in one embodiment of the present disclosure, the information display module 702 is further used for displaying the task information in the document page in response to a trigger operation on an insert control or the task information in the first interface.

Optionally, in one embodiment of the present disclosure, the information display module 702 is further used for simultaneously displaying subordinate task information of the task information, content of the subordinate task information being associated with content of the task information.

Optionally, in one embodiment of the present disclosure, the apparatus further includes component displaying module, used for displaying a content input component in a region associated with the task information, or displaying a content input component in a region associated with the subordinate task information.

Optionally, in one embodiment of the present disclosure, the apparatus further includes information sending module, used for determining whether a current user is the same as the target user, and if not, sending a prompt message to the target user, the prompt message comprising identification information of the document.

Optionally, in one embodiment of the present disclosure, the information sending module sending the prompt message to the target user includes sending the prompt message to an instant messaging client of the target user by means of an associated message robot.

Optionally, in one embodiment of the present disclosure, the interface displaying module 701 is used for displaying a second interface in response to receiving of information of the target user in the document page; and displaying the first interface in response to selection of a task control in the second interface.

Optionally, in one embodiment of the present disclosure, the interface displaying module 701 is used for displaying a trigger component in response to a selection operation of a content line in the document page; displaying a third interface in response to a trigger operation on the trigger component; and displaying the first interface in response to selection of a task control in the third interface.

Regarding the apparatuses of the above embodiments, the specific manner in which the respective modules perform operations and the corresponding technical effects have been described in detail corresponding to the embodiment of the method, which will not be described in detail herein.

It should be noted that although several modules or units of equipment used for action execution are mentioned in the detailed description above, this division is not mandatory. In fact, according to the implementation methods of the present disclosure, the features and functions of two or more modules or units described above may be concretized in one module or unit. Conversely, the features and functions of a module or unit described above may be further divided into multiple modules or units to concretize. The components displayed as modules or units may be or may not be physical units, that is, the components may be located in one place or distributed to multiple network units. Some or all of the modules may be selected according to actual needs to achieve the purpose of the present disclosure. Ordinary technicians in this field may understand and implement them without creative labor.

The present disclosure further provides a non-transitory computer-readable storage medium storing a computer program thereon. The computer program is executed by a processor to implement the steps of any one of the above-described embodiments of the document information processing method.

Exemplary, the readable storage medium can be, for example, but not limited to, electrical, magnetic, optical, electromagnetic, infrared, or semiconductor systems, devices, or any combination thereof. More specific examples of readable storage media (non-exhaustive list) include: electrical connections with one or more wires, portable disks, hard disks, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination thereof.

The non-transitory computer-readable storage medium may include data signals propagated in baseband or as part of a carrier wave, which carry readable program code. Such propagated data signals can take many forms, including but not limited to electromagnetic signals, optical signals, or any suitable combination thereof. The readable storage medium can also be any readable medium other than the readable storage medium, which can send, propagate, or transmit programs for use by or in conjunction with instruction execution systems, devices, or devices. The program code contained on the readable storage medium can be transmitted using any suitable medium, including but not limited to wireless, wired, optical cable, RF, etc., or any suitable combination thereof.

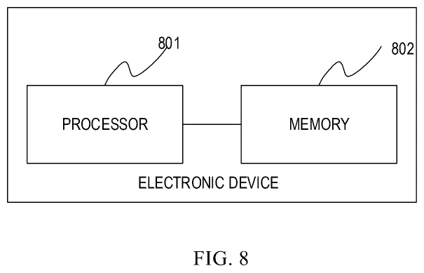

The present disclosure further provides an electronic device, the electronic device shown in FIG. 8 may include a processor 801 and a memory 802, a memory 802 for storing a computer program.

It should be noted that in this article, relational terms such as “first and “second” are only used to distinguish one entity or operation from another entity or operation, and do not necessarily require or imply any actual relationship or order between these entities or operations. Moreover, the terms “including” and “comprising”, or any other variant thereof are intended to cover non-exclusive inclusion, so that a process, method, article, or device that includes a series of elements not only includes those elements, but also includes other elements not explicitly listed, or includes elements inherent to such processes, methods, articles, or devices. Without further restrictions, the element defined by the statement “including a . . . ” does not exclude the existence of other identical elements in the process, method, article, or device that includes the element. The term “based on” refers to “based at least in part on”. The term “in response to” and related terms refer to a signal or event being affected to a certain extent by another signal or event, but not necessarily completely or directly. If event x occurs “in response to” event y, then x may respond directly or indirectly to y. For example, the appearance of y may ultimately lead to the appearance of x, but there may be other intermediate events and/or conditions. In other cases, y may not necessarily lead to the appearance of x, and even if y has not yet occurred, x may still occur. In addition, the term “in response to” may also mean “at least partially responding to”. The term “determining” broadly covers a variety of actions, including acquisition, calculation, calculation, processing, deduction, investigation, search (e.g., searching in tables, databases, or other data structures), exploration, and similar actions, as well as receiving (e.g., receiving information), accessing (e.g., accessing data in memory), and similar actions, as well as parsing, selecting, selecting, establishing, and similar actions.

The foregoing is merely a detailed description of the disclosure to enable those skilled in the art to understand or implement the disclosure. Various modifications to these embodiments will be apparent to those skilled in the art, and the general principles defined herein may be implemented in other embodiments without departing from the spirit or scope of the disclosure. Accordingly, the disclosure will not be limited to the embodiments described herein, but will be subject to the widest scope consistent with the principles and novel features disclosed herein.

1. A method for information processing, comprising:
displaying a first interface in response to an input request received in a document page; and
displaying at least one piece of task information of a target user and reminder information of the task information in the first interface in response to a selection operation of a target user.

2. The method according to claim 1, wherein displaying the reminder information of the task information comprises:
displaying first reminder information in a first region of the first interface.

3. The method according to claim 1, wherein displaying the reminder information of the task information comprises:
displaying second reminder information in a second region associated with a display region of the task information in the first interface, the second reminder information being determined based on a confidentiality type of the task information.

4. The method according to claim 3, further comprising:
before displaying the second reminder information in the second region associated with the task information in the first interface,
setting a confidentiality type of the task information to a first type in a client associated with the task information, the first type indicating that the task information is confidential information.

5. The method according to claim 1, wherein selection operation on the target user comprises:
entering information of the target user in an editing region of the document page associated with the first interface; or entering information of the target user in a specified region of the first interface.

6. The method according to claim 1, wherein the first interface further comprises a search component; and displaying the at least one piece of task information of the target user in the first interface comprises:
in response to input content received in the search component, displaying the target user corresponding to the input content and at least one piece of task information of the target user in the first interface.

7. The method according to claim 1, further comprising:
displaying the task information in the document page in response to a trigger operation on an insert control or the task information in the first interface.

8. The method according to claim 7, further comprising:
simultaneously displaying subordinate task information of the task information, content of the subordinate task information being associated with content of the task information.

9. The method according to claim 8, further comprising:
displaying a content input component in a region associated with the task information, or displaying a content input component in a region associated with the subordinate task information.

10. The method according to claim 1, further comprising:
determining whether a current user is the same as the target user, and if not, sending a prompt message to the target user, the prompt message comprising identification information of the document.

11. The method according to claim 10, wherein sending the prompt messages to the target user comprises:
sending the prompt message to an instant messaging client of the target user by means of an associated message robot.

12. The method according to claim 1, wherein displaying the first interface in response to the input request for receiving the task information in the document page comprises:
displaying a second interface in response to receiving of information of the target user in the document page; and
displaying the first interface in response to selection of a task control in the second interface.

13. The method according to claim 1, wherein displaying the first interface in response to the input request for receiving the task information in the document page comprises:
displaying a trigger component in response to a selection operation of a content line in the document page;
displaying a third interface in response to a trigger operation on the trigger component; and
displaying the first interface in response to selection of a task control in the third interface.

14. (canceled)

15. (canceled)

16. An electronic device comprising:
a processor; and
a memory for storing a computer program;
wherein the computer program, when executed by the processor, cause the electronic device to perform operations comprising:
displaying a first interface in response to an input request received in a document page; and
displaying at least one piece of task information of a target user and reminder information of the task information in the first interface in response to a selection operation of a target user.

17. The electronic device according to claim 16, wherein displaying the reminder information of the task information comprises:
displaying first reminder information in a first region of the first interface.

18. The electronic device according to claim 16, wherein displaying the reminder information of the task information comprises:
displaying second reminder information in a second region associated with a display region of the task information in the first interface, the second reminder information being determined based on a confidentiality type of the task information.

19. The electronic device according to claim 18, the operations further comprising:
before displaying the second reminder information in the second region associated with the task information in the first interface, setting a confidentiality type of the task information to a first type in a client associated with the task information, the first type indicating that the task information is confidential information.

20. The electronic device according to claim 16, wherein the selection operation on the target user comprises:
entering information of the target user in an editing region of the document page associated with the first interface; or entering information of the target user in a specified region of the first interface.

21. The electronic device according to claim 16, wherein the first interface further comprises a search component; and displaying the at least one piece of task information of the target user in the first interface comprises:
in response to input content received in the search component, displaying the target user corresponding to the input content and at least one piece of task information of the target user in the first interface.

22. A non-transitory computer-readable storage medium, wherein the computer readable-storage medium stores instructions which, when executed on an electronic device, cause the electronic device to perform operations comprising:
displaying a first interface in response to an input request received in a document page; and
displaying at least one piece of task information of a target user and reminder information of the task information in the first interface in response to a selection operation of a target user.
